(19) United States
(12) Patent Application Publication
(10) Pub. No.: US 2011/0314388 A1
(43) Pub. Date: Dec. 22, 2011

(54) METHOD AND APPARATUS FOR GENERATING A COLLABORATIVE PLAYLIST

(75) Inventor: Mark David Wheatley, Bristol (GB)

(73) Assignee: Nokia Corporation, Espoo (FI)

(21) Appl. No.: 12/818,913

(22) Filed: Jun. 18, 2010

(51) Int. Cl. G06F 3/01; G06F 15/16

(52) U.S. Cl. 715/751

(57) ABSTRACT

An approach is provided for generating a collaborative playlist. An input for initiating creation of a collaborative playlist is received. The collaborative playlist can be based, at least in part, on one or more criteria. A notification of the collaborative playlist is determined to be transmitted to one or more devices. Respective users of the one or more devices are used to update the collaborative playlist.

### BACKGROUND

Service providers and device manufacturers (e.g., wireless, cellular, etc.) are continually challenged to deliver value and convenience to consumers by, for example, providing compelling network services. Such services can include one or more social networking services such as Facebook®, Twitter®, MySpace®, etc. Further, network services may include one or more media services, such as the Nokia® Music Store. Many media services and technologies offer the opportunity to generate playlists. With these technologies, users are generally able to create playlists for themselves and/or to share made playlists with other users. However, because social services and media services are generally separate, significant technical challenges arise in utilizing both social networking services and media services to generate a playlist.

### SOME EXAMPLE EMBODIMENTS

Therefore, there is a need for an approach for collaboratively generating playlists.

According to one embodiment, a method comprises receiving an input for initiating the creation of a collaborative playlist, the collaborative playlist based, at least in part, on one or more criteria. The method also comprises determining to transmit a notification of the collaborative playlist to one or more devices. The respective users of the one or more devices iteratively update the collaborative playlist.

According to another embodiment, a method comprising facilitating access to at least one interface configured to allow access to at least one service, the at least one service configured to perform at least receiving an input for initiating the creation of a collaborative playlist, the collaborative playlist based, at least in part, on one or more criteria. The method also comprises determining to transmit a notification of the collaborative playlist to one or more devices. The respective users of the one or more devices iteratively update the collaborative playlist.

According to another embodiment, an apparatus comprising at least one processor, and at least one memory including computer program code, the at least one memory and the computer program code configured to, with the at least one processor, cause, at least in part, the apparatus to receive an input for initiating the creation of a collaborative playlist, the collaborative playlist based, at least in part, on one or more criteria. The apparatus is also caused to determine to transmit a notification of the collaborative playlist to one or more devices. The respective users of the one or more devices iteratively update the collaborative playlist.

According to another embodiment, a computer-readable storage medium carrying one or more sequences of one or more instructions which, when executed by one or more processors, cause, at least in part, an apparatus to receive an input for initiating the creation of a collaborative playlist, the collaborative playlist based, at least in part, on one or more criteria. The apparatus is also caused to determine to transmit a notification of the collaborative playlist to one or more devices. The respective users of the one or more devices iteratively update the collaborative playlist.

According to another embodiment, an apparatus comprises means for receiving an input for initiating the creation of a collaborative playlist, the collaborative playlist based, at least in part, on one or more criteria. The apparatus also comprises means for determining to transmit a notification of the collaborative playlist to one or more devices. The respective users of the one or more devices iteratively update the collaborative playlist.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of collaboratively generating playlists, according to one embodiment;

FIG. 2 is a diagram of the components of a media service platform, according to one embodiment;

FIG. 3 is a flowchart of a process for collaboratively generating playlists, according to one embodiment;

FIG. 4 is a ladder diagram for a process for collaboratively generating playlists, according to one embodiment;

FIGS. 5A-5B are diagrams of a flow of actions used for collaboratively updating playlists, according to various embodiments;

FIGS. 6A-6B are diagrams of user interfaces utilized in the processes of FIG. 3, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for collaboratively generating playlists are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

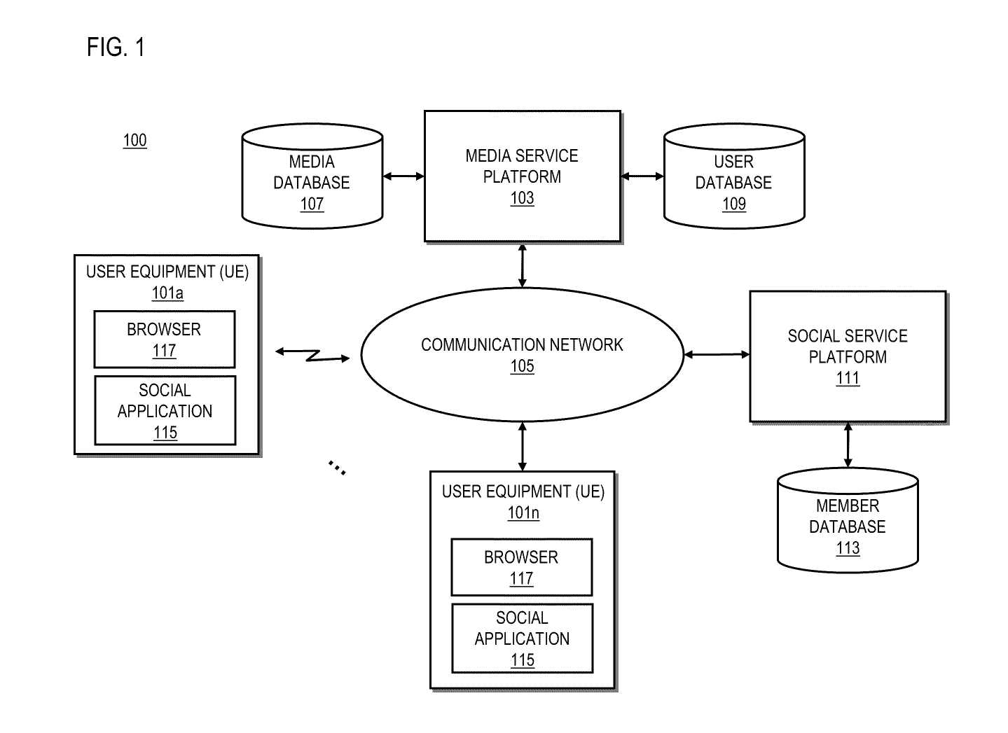

FIG. 1 is a diagram of a system capable of collaboratively generating playlists, according to one embodiment. In certain embodiments, media is a tool used to store and/or deliver information or data. By way of example, forms of media include audio, video, games, electronic books, pictures, text, other content formats, etc. Moreover, such media may be accessed, transported, or otherwise managed as one or more files, streams, or other communications forms. Further, it is noted that these media files, streams, etc. may be organized and/or separated as tracks, chapters, volumes, levels, and the like, that can then be combined into playlists that specify, among other things, a selection of tracks and a corresponding playback order of the tracks. For example, an audio media track may be a single file or audio stream that may be associated with other audio media tracks into one or more playlists (e.g., the audio media track may be part of an album). Similarly, a video media track may be associated with other video media tracks as one or more playlists (e.g., scenes in a larger production).

Historically, users (e.g., consumers, recording artists, music publishers, etc.) have created playlists in relative isolation. In other words, the process of creating a playlist usually involves a single user who compiles a playlist on his or her own. Although, the playlist may be ultimately shared, the playlist creation process has remained a mostly solitary exercise. However, as social networking services have increased in use and popularity, users are quickly becoming more accustomed to and expect more social forms of interaction. As a result, media service providers, device manufacturers, and the like are challenged to make the playlist creation process more interactive. To meet this challenge, service providers and others face hurdles such as the traditional separation between social networking services and media services into different services and applications. This separation, in turn, leads both technical limitations to interactivity between media and social networking services (e.g., lack of application programming interfaces between the services) and non-technical limitation s (e.g., inadequate licensing rights to allow for the use of media on the social services).

To address this problem, a system 100 of FIG. 1 introduces the capability to collaboratively generate playlists utilizing existing social networks and/or messaging systems. More specifically, in the approach described herein, one or more user equipment (UEs) 101a-101n can cause transmission of a request for initiating creation of a collaborative playlist to a media service platform 103 over a communication network 105. This request may be received as input at the media service platform 103. Further, the request can specify one or more criteria. In certain embodiments, the criteria describe the content to be included in the collaborative playlist (e.g., themes, references, etc.). In one example, the criteria can include one or more types of media (e.g., audio, video, games, electronic books, pictures, text, etc.). In another example, the criteria can include one or more genres of content type (e.g., rock, punk, alternative, rap, love songs, classical music, contemporary music, dance music, popular music, instrumental music, house, country music, trance, etc.). Additionally other categories may be utilized in selection criteria (e.g., music associated with a time period, music associated with a movie, happy music, sad music, romantic music, video clips associated with a show, etc.). Further, the criteria may include customized mixes of media types, content types, other categories, etc. When received by the media service platform 103, the request is parsed and the creation of a collaborative playlist is initiated. The collaborative playlist can be hosted (e.g., via an application programming interface (API), a web page, etc.) by the media service platform 103.

The media service platform 103 can include a media database 107 and a user database 109. The media database 107 can include media content (e.g., audio tracks, video tracks, etc.), playlists (e.g., the created collaborative playlist), etc. The user database 109 may include user information (e.g., username, password, full name, first name, last name, address, e-mail address, phone number, associated service type, etc.). By way of example, an associated service type may include features available to the user, licenses for content, a subscription, etc. The hosting of the collaborative playlist by the media service platform 103 can include availability of content associated with the playlist to other users. In certain embodiments, the other users may be required to register for an account (e.g., subscribe to the service), utilize a guest/anonymous public account, or the like. In other embodiments, the other users may be required to utilize a link associated with the user that created the collaborative playlist to receive content. In this manner the other users are associated with the collaborative playlist.

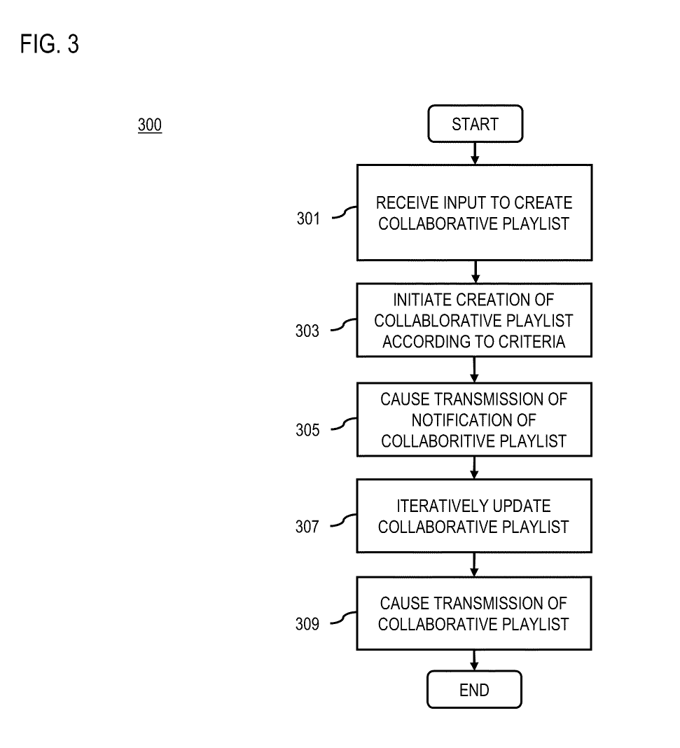

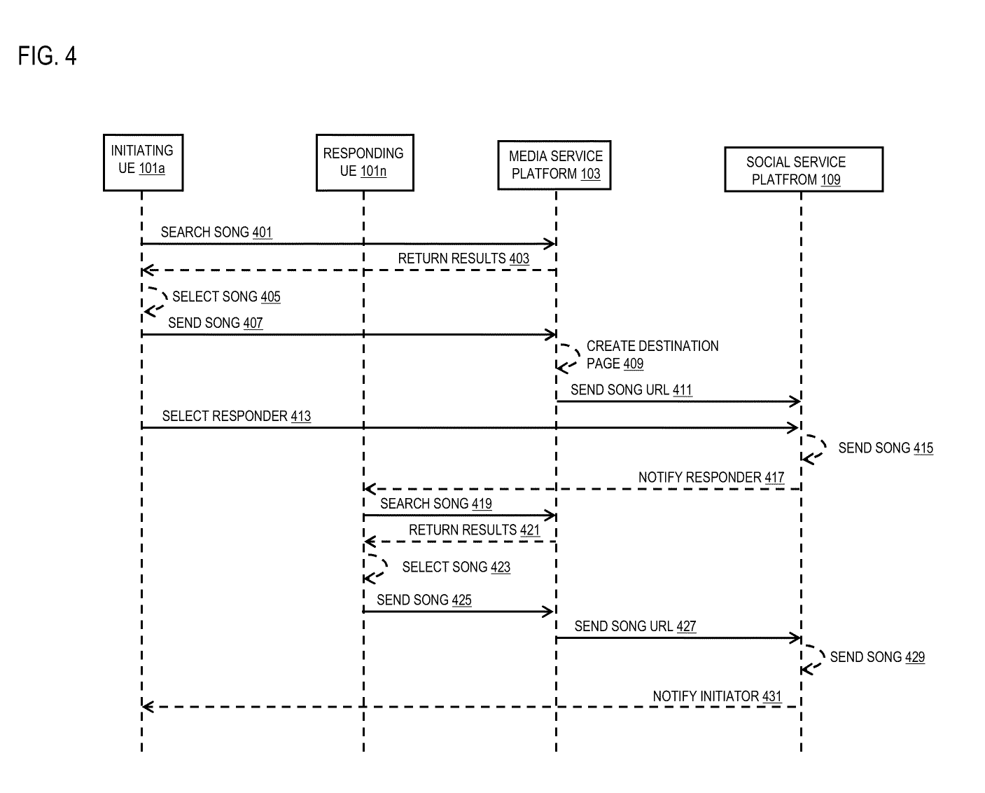

The media service platform 103 may additionally store other users associated with the initiating user in the user database 109 as associated with the user. Moreover, the media service platform 103 can receive a request to send a notification of the collaborative playlist to the other users. This may be accomplished via one or more social service platforms 111 connected via the communication network 105. The social service platform 111 may include one or more of social networking services, messaging services (e.g., Short Message Service (SMS), Multimedia Messaging Service (MMS), instant messaging), etc. Examples of social networking services include social networking websites and services (e.g., Facebook™, Twitter™, MySpace™, etc.), as well as other computing devices (e.g., a server to coordinate communications between UEs 101). Further, the media service platform 103 and the social service platform 111 may include APIs to communicate with each other. In certain embodiments, one or more of the other users are associated with the social service platform 111 in a member database 113. For example, the initiating user can have contacts (e.g., friends, colleagues, co-workers, family, etc.) and or groupings of contacts stored in the member database 113 as associated with the initiating user. The member database 113 may be utilized in determining one or more notifications to send to the other users. Then, the media service platform 103 and/or social service platform 111 can be caused to send update notifications to the other users as further described in FIGS. 3 and 4.

The other users receive the notification via a social application 115. In certain scenarios, the social application (e.g., a social networking application, a contacts application, a messaging application, a browser embedded program, etc.) is utilized to present the collaborative playlist and/or a link (e.g., a universal resource link (URL) and/or identifier) to the collaborative playlist. The user may select the playlist and/or link to initiate the use of a browser 117 and/or other API to view the collaborative playlist. Further, the user may be asked to update the collaborative playlist according to the criteria.

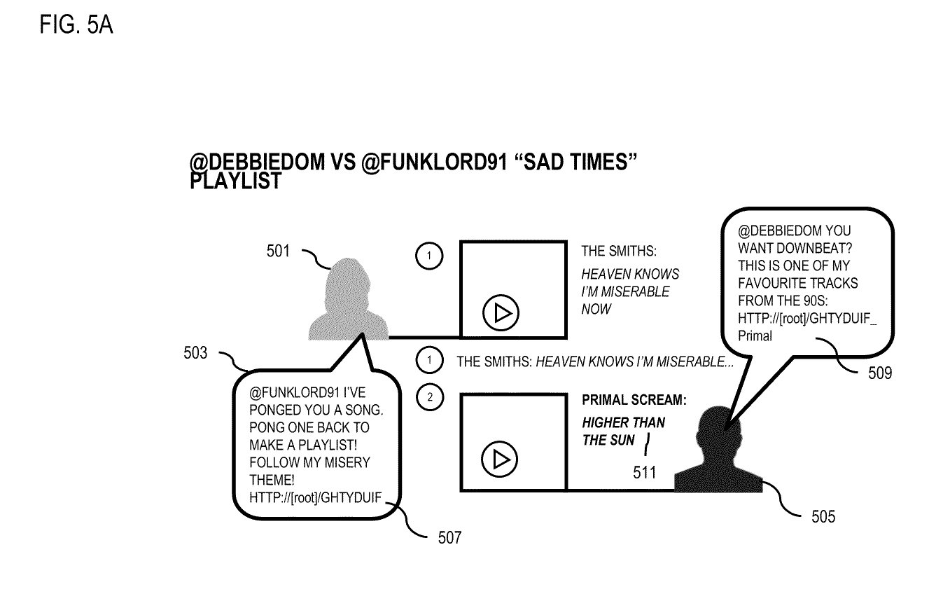

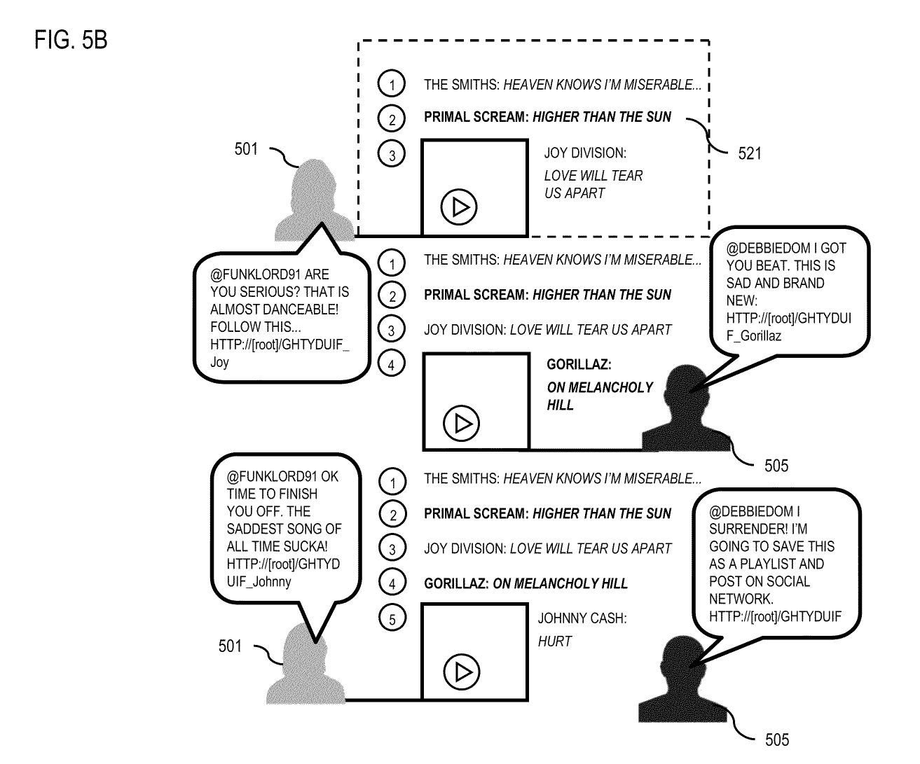

To update the collaborative playlist, the user may search for a media track (e.g., a song) via a query to the media service platform 103, which queries the media database 107 to retrieve results to the query. The user is then presented the results via the UE 101. A media track can then be selected to add to the collaborative playlist and sent to the media service platform 103. The media service platform 103 then causes update of the collaborative playlist. The media service platform 103 may check the selected media track to determine whether the selected media track is associated with the criteria. This determination may be utilized to filter unresponsive media tracks from the collaborative playlist. Further, the media service platform 103 may utilize the social service platform 111 and/or another social service platform 111 to cause transmission of another notification of the addition of the media track to the initiator user and/or other users. This process may continue iteratively indefinitely, until a threshold number of tracks are added, until a threshold time period is met, or the like. Example updates of the media tracks are further detailed in FIGS. 5A and 5B.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In certain embodiments, the actions of the media service platform 103 and/or social service platform 111 can be combined. In other embodiments, the actions and/or functionality of the media service platform 103 and/or social service platform 111 may be split among one or more other platforms.

By way of example, the UE 101, media service platform 103, and social service platform 111 communicate with each other and other components of the communication network 105 using well known, new or still developing protocols. In this context, a protocol includes a set of rules defining how the network nodes within the communication network 105 interact with each other based on information sent over the communication links The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, media service platform 103 and/or social service platform 111 may interact according to a client-server model with the social applications 115 of the UE 101. According to the client-server model, a client process sends a message including a request to a server process, and the server process responds by providing a service (e.g., messaging, social networking services, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

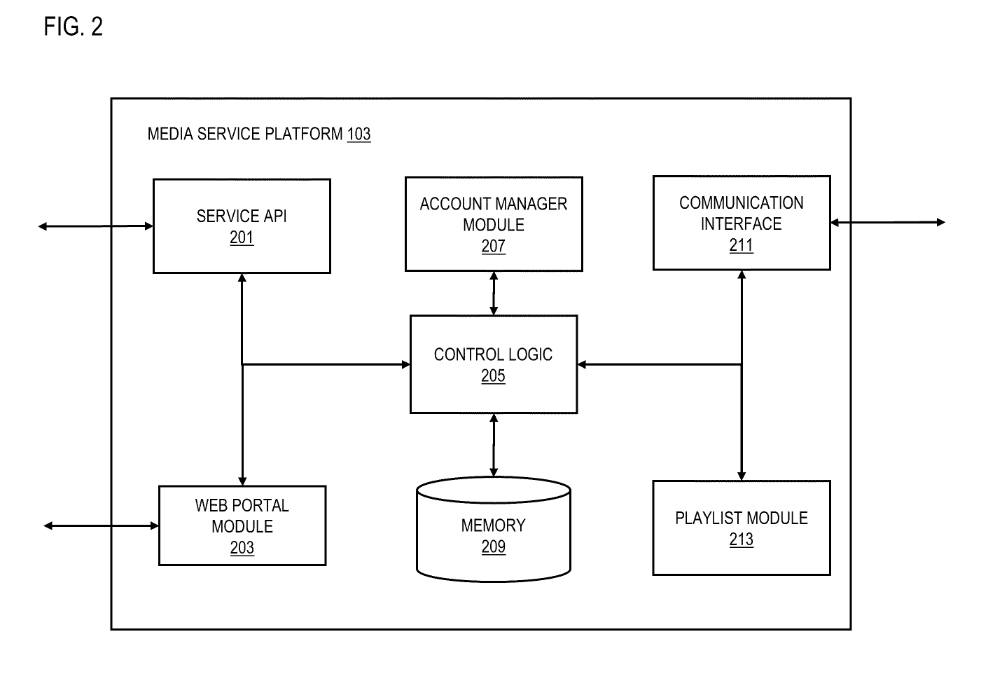

FIG. 2 is a diagram of the components of a media service platform, according to one embodiment. By way of example, the media service platform 103 includes one or more components for collaboratively generating playlists. It is contemplated that the functions of these components may be combined in one or more components or performed by other components of equivalent functionality. In this embodiment, the media service platform 103 includes a service API 201, a web portal module 203, control logic 205, an account manager module 207, memory 209, a communication interface 211, and a playlist module 213.

The control logic 205 can be utilized in controlling the execution of modules and interfaces of the media service platform 103. The program modules can be stored in the memory 209 while executing. A communication interface 211 can be utilized to interact with UEs 101 (e.g., via a communication network 105). Further, the control logic 205 may utilize a service API 201 (e.g., in conjunction with the communication interface 211) to interact with social service platforms 111 and/or other platforms.

The communication interface 211 may include multiple means of communication. For example, the communication interface 211 may be able to communicate over SMS, internet protocol, instant messaging, voice sessions (e.g., via a phone network), or other types of communication. The communication interface 211 can be used by the control logic 205 to communicate with UEs 101, the social service platforms 111, and other devices. In some examples, the communication interface 211 is used to transmit and receive information using protocols and methods associated with the service API 201.

By way of example, the playlist module 213 may be utilized to generate a collaborative playlist. Further, the playlist module 213 can be utilized to generate notifications to send to UEs 101 via the communication interface 211 and/or service API 201. Moreover, the playlist module 213 can coordinate with a web portal module 203 to facilitate access to generated playlists. As such, the web portal module 203 can generate a webpage and/or a web access API to allow UEs 101 to access the generated playlists. Further, the web portal module 203 can be utilized to allow for access via a social service platform 111. For example, a webpage of the social service platform 111 may embed content (e.g., via HyperText Markup Language (HTML) 5, Adobe Flash, Microsoft Silverlight, etc.) associated with the playlist. In this manner, a user may include a link to the playlist on the user's social networking site. This link may be utilized to access the playlist by other users. Further, the social service may provide other means (e.g., messaging, wall/blog messages/postings, etc.) to notify users of the playlist.

In one embodiment, the media service platform 103 can facilitate access to at least one user interface configured to allow access to at least one service. The at least one service can be configured to perform various processes. As such, the media service platform 103 and/or one or more of the components of the media service platform 103 can be means for performing various processes.

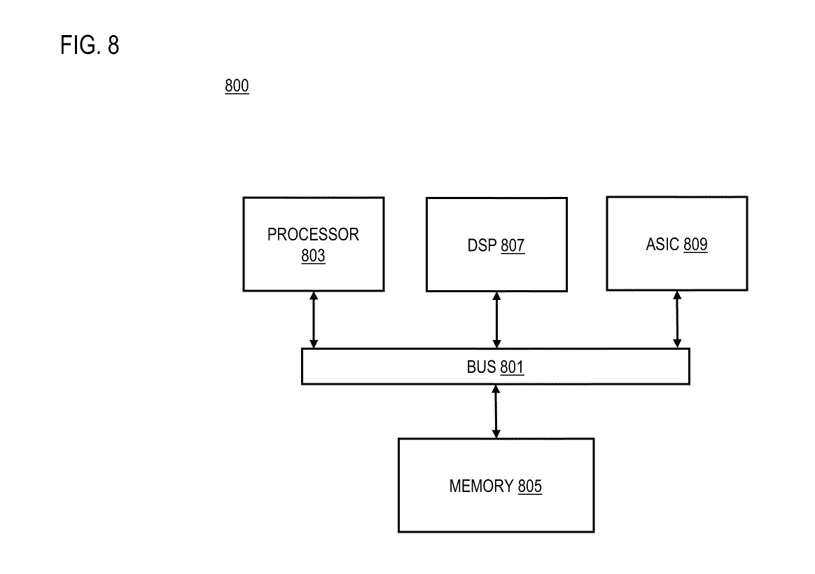

FIG. 3 is a flowchart of a process for collaboratively generating playlists, according to one embodiment. In one embodiment, the control logic 205 and/or other components of the media service platform 103 performs the process 300 and is implemented in, for instance, a chip set including a processor and a memory as shown in FIG. 8. As such, the control logic 205 can provide means for accomplishing various parts of the process 300 as well as means for accomplishing other processes in conjunction with other components of the media service platform 103 and/or social service platform 111.

In step 301, the control logic 205 receives an input, e.g., from an initiating UE 101a, for initiating creation of a collaborative playlist. The collaborative playlist can be based, at least in part, on one or more criteria. As noted above, in certain embodiments, the criteria describe the content to be included in the collaborative playlist. By way of example, the criteria can include one or more types of media genres of content type, or other categories may be utilized in selection criteria. Further, the criteria may include customized mixes of media types, content types, other categories, etc. In other embodiments, the criteria may additionally include control rules. For example, a control rule may include a list of users that are authorized to add to the playlist, a maximum threshold limit for media tracks to add to the playlist, determining rights of whether a user is allowed to receive content (e.g., media tracks) associated with the collaborative playlist, etc. In some embodiments, some or all of the criteria are specified via one or more requests. In other embodiments, some or all of the criteria may be specified by the media service platform 103 and/or other sources.

Then, the control logic 205 initiates creation of the collaborative playlist according to the criteria (step 303). In certain scenarios, the initiating UE 101a can be associated with the collaborative playlist (e.g., as an initiator). As such, the initiating UE 101a and/or a user of the initiating UE 101a can be associated with the playlist based on an account. Further, in certain embodiments, one or more licenses to media content on the playlist can be based, at least in part, on the account. For example, the user may have a license to allow all public users or a certain number of guest users to view the playlist and/or the media tracks associated with the playlist. In another example, the user may have another license that allows only a limited play of the media to be allowed for guest users and/or public users. This can be beneficial for the media service platform 103 by increasing traffic to the media services of the platform. In this manner, the media service platform 103 may advertise or allow other users with limited access to join the media service. With this approach, the media service platform 103 may encourage additional users (e.g., contacts of the user of the initiating UE 101a) to join the media service.

Further, the control logic 205 can determine to transmit a notification of the collaborative playlist to one or more UEs 101a-101n (step 305). The notification may be generated corresponding to a request of the initiating UE 101 and/or based on a preset contact list. Further, the notification may be caused to be transmitted via the social service platform 111 (e.g., via a social network, a text message, a multimedia message, an electronic mail, an instant message, a combination thereof, etc.).

Then, at step 307, the control logic 205 iteratively updates the collaborative playlist based on information received from respective users of the UEs 101. For example, the control logic 205 can receive from one of the UEs (e.g., UE 101n) a media track selection to add to the collaborative playlist. This media track selection may be based on media that the user of the UE 101n searches for and selects as further detailed in FIG. 4. Further, once received, the control logic 205 can determine whether the media track selection is substantially within the one or more criteria. For example, the media track selection can be substantially within the criteria if it meets one of the criteria. In one example, if the criteria allows for romance songs and depressing songs, and the media track selection is a romance song, the media track selection substantially meets the criteria. In some examples, some or all of the criteria must be met. For example, in certain embodiments, the track selection may be limited to audio and/or video. If the criteria are substantially met, the control logic 205 causes, at least in part, update of the collaborative playlist.

Then, the control logic 205 determines to transmit a notification of the media track selection to the UEs 101 (e.g., including the initiating UE 101a and/or one or more other UEs 101). The notification can be generated and then caused to be transmitted via one or more social service platforms 111. In one embodiment, the notification includes a link (e.g., a URL) to the collaborative playlist. In another embodiment, the URL specifies the selected media track as a track to play when a user executes the URL. Once the notification is transmitted, other users can iteratively add to the collaborative playlist.

In one embodiment, the iterative playlist is generated by the initiating UE 101a and one other UE 101n. In this embodiment, the media tracks can be added one by one with each user taking a turn. Metaphorically, the iterations of adding tracks can be like ping pong, where one user adds a media track and sends the link to the other user to add an additional media track. Further, the users may comment on previous selections. In another embodiment, the users may send the links to the collaborative playlist round robin to allow another user in a queue or other users to add media tracks to the collaborative playlist iteratively. Once again, the users may comment on previous iterations.

Then, at step 309, the control logic 205 can determine to transmit the collaborative playlist to a one or more UEs 101. The transmission may include posting the collaborative playlist via the social service platform 111, providing links to the collaborative playlist, etc. Then, individual users may select links to the collaborative playlist to access the collaborative playlist.

FIG. 4 is a ladder diagram for a process for collaboratively generating playlists, according to one embodiment. A network process on the network is represented by endpoints of the vertical lines. A message passed from one process to another is represented by horizontal arrows. A step performed by a process is indicated by the text. The processes represented in FIG. 4 can be utilized to collaboratively generate playlists. In this example embodiment, the media tracks utilized correspond to a music service, however, it is noted that various types of media are contemplated to be used.

At step 401 an initiating UE 101a searches for a song from the media service platform 103. A search query can be generated at the initiating UE 101a and be caused to be transmitted to the media service platform 103. In response, the media service platform 103 can search a media database 107 for song results that correspond to the search query. The search may be conducted using conventional technologies. Then, at step 403, the media service platform 103 can determine to cause transmission of the results to the initiating UE 101a. The results may include one or more URLs linking to media content, a playlist, the media service platform 103, a web portal, etc. associated with the results. The initiating UE 101a can then select a song from the song results (step 405).

The initiating UE 101 may then cause sending of the song to the media service platform 103 (step 407). In one embodiment, this may entail generating a request to create a collaborative playlist and/or publish a collaborative playlist. Further, the sending of the song may include generating and sending criteria to the media service platform 103 corresponding to a theme, genre, etc. of the playlist. Then, as previously described, the media service platform 103 creates a destination page to host the collaborative playlist (step 409). Once the collaborative playlist and associated webpage are generated, the media service platform 103 causes sending of a URL to the social service platform 111 to notify other UEs 101 (step 411). In certain embodiments, the URL includes an identifier of the collaborative playlist. Further, the initiating UE 101a can select a responder (e.g., a user to help generate the collaborative playlist) to send the song and/or song URL to (step 413). A selection message can be generated at the initiating UE 101a and transmitted to the social service platform 111. This selection message can cause the social service platform 111 to forward the song and/or song URL (step 415). As such, a notification can be caused to be sent to the responding UE 101n (step 417). In certain embodiments, the notification may include a URL linking to the media content, the collaborative playlist, etc. In certain embodiments, the notification is generated by the media service platform 103, the social service platform 111, the initiating UE 101a, or a combination thereof.

The responding UE 101n can then search for a song at the media service platform 103. The notification received at the responding UE 101n can include criteria for adding to the collaborative playlist. Further, the notification may include a message from the user of the initiating UE 101a (e.g., as described in FIGS. 5A and 5B). The user of the responding UE 101n can then cause generation of a song search query and send a song search query to the media service platform 103 (step 419). The media service platform 103 can then generate and return results (e.g., including one or more URLs to information stored on the media service platform 103) to the responding UE 101n (step 421). The user of the responding UE 101a can enter input to select a song from the results (step 423) and cause sending of the song to the media service platform 103 (step 425). In this manner, the song can be added to the collaborative playlist. In certain embodiments, the song can be compared to one or more of the criteria for adding to the collaborative playlist to ensure a quality playlist. Additionally or alternatively, song search results may be filtered according to the criteria so that song search results do not show song results that do not meet or substantially meet the criteria.

At step 427, the media service platform 103 causes sending of a song URL to the social service platform 111. In one embodiment, the song URL can include an identifier for the collaborative playlist as well as an identifier for the added song. In this manner, other users may be directed to the playlist and the song when executing the URL. Then, the media service platform 103 can cause the social service platform 111 to send the song (step 429) to the initiating UE 101a by generating and sending a notification. As such, the social service platform 111 can cause notification to the initiating UE 101a (step 431). Once again, this notification may include one or more URLs linking to the media content and/or collaborative playlist (e.g., via a web portal).

FIGS. 5A-5B are diagrams of a flow of actions used for collaboratively updating playlists, according to various embodiments. A collaborative playlist can be initiated by a first user 501 in the form of a game between users. In this example embodiment, the first user selects a song on a media service platform 103 to initiate a playlist. The song can be found in a music catalog and can be searched via one or more mechanisms via one or more canvases (e.g., webpage, UE client, desktop client, etc.). The user can add a message 503 and cause the media service platform 103 to message a second user 505. In this example, the first user chooses to initiate a collaborative playlist with a misery theme. The first user may select, as noted above, criteria defining the associated music on the playlist to be within the misery theme. Further, the message may include a URL 507 specifying the playlist. A messaging channel of the social service platform 111 may be used to cause notification of the message to the second user 505.

The second user 505 can receive the notification message and reply by searching for and/or selecting a song for the playlist. This song may be represented by a URL 509 to the playlist additionally specifying the selected song 511. As shown in FIG. 5B, the second user 505 can cause sending of another notification back to the first user 501. The interaction may go on infinitely or until an event occurs (e.g., a threshold or maximum number of songs on the playlist is met, a single song share, a predefined time event, etc.). As such, the interaction between the first user 501 and the second user 505 creates a playlist (e.g., playlist 521). Further, the playlist may be accessed at any time via the media service platform 103 (e.g., via a webpage, via an embedded stream-player in a blog or social network page associated with the media service platform 103, etc.). As noted previously a link can be utilized in customizing the playlist and/or the play of the playlist. Further, scripting technologies and APIs associated with the social service platform 111 can be utilized in notifying users of the collaborative playlist.

In certain embodiments, when the playlist is completed, a user (e.g., the second user 505) can save the playlist (e.g., to the UE 101 of a user, a desktop music player, posted to a website or blog, etc.). Further, the playlist may be shared over a social network. In this manner, additional users may be able to utilize the collaborative playlist. In certain embodiments, the collaborative playlist may be utilized to drive traffic towards the media service platform 103. For example, the second user 505 may not be a member of a service of the media service platform 103 while the first user 501 is a member of the media service platform 103. In this embodiment, the second user 505 may be allowed to utilize a limited capability portion of the media service. For example, media tracks may be playable to the second user 505 for a limited threshold time (e.g., a 30 second clip), lower quality, etc. Moreover, the second user 505 may be prompted to buy or subscribe to the media track and/or service.

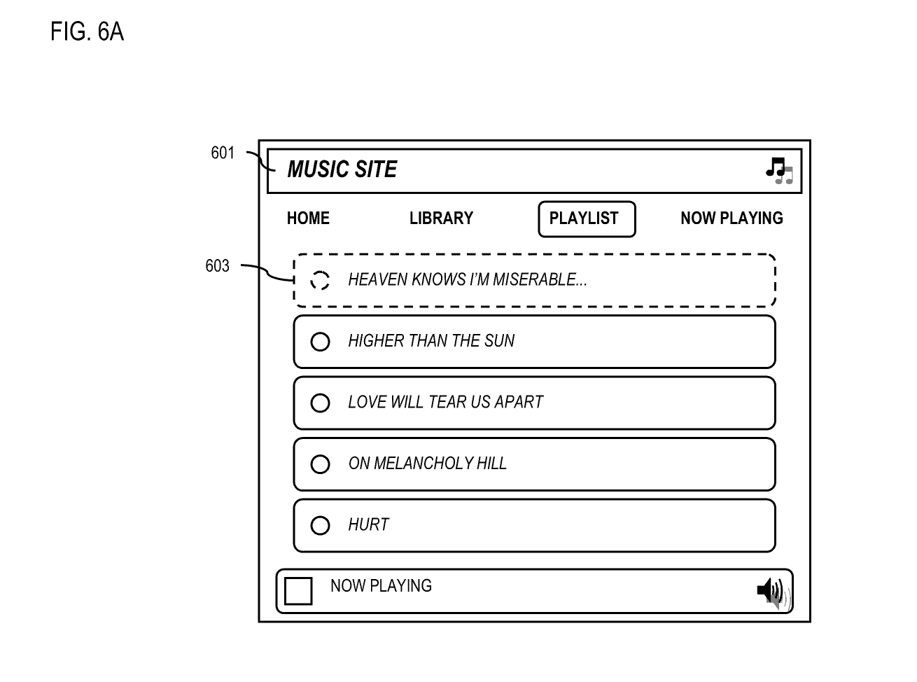

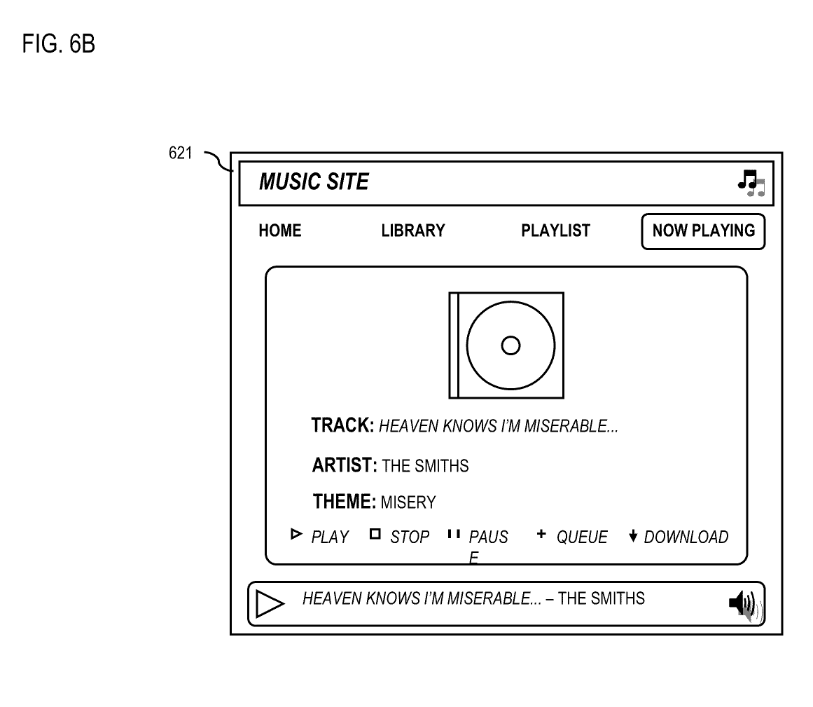

FIGS. 6A-6B are diagrams of user interfaces utilized in the processes of FIG. 3, according to various embodiments. User interface 601 shows a web version of a media service platform webpage associated with a music site. The music site can include a collaborative playlist. In this example, one of the media tracks 603 can be selected for playing. The playing of the media track 603 can be based on selection and execution of a URL. Further, in user interface 621, the playing track with additional information can be shown. For example, the additional information may include a theme associated with criteria for the collaborative playlist.

With the above approaches, collaborative playlists can be generated via a transactional conversation. The iterative collaborative playlist updating can act as a media game to present a media service to users socially to create brand awareness and to obtain new customers, thus increasing traffic to the service. The more users that use the service, the more efficient and/or economical the service. Further, the iterative collaborative playlist allows for the use of existing messaging channels and/or social infrastructure to generate the collaborative playlist. Because storage of the playlist is on a globally available page, more users can access the services.

The processes described herein for providing generation of a collaborative playlist may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

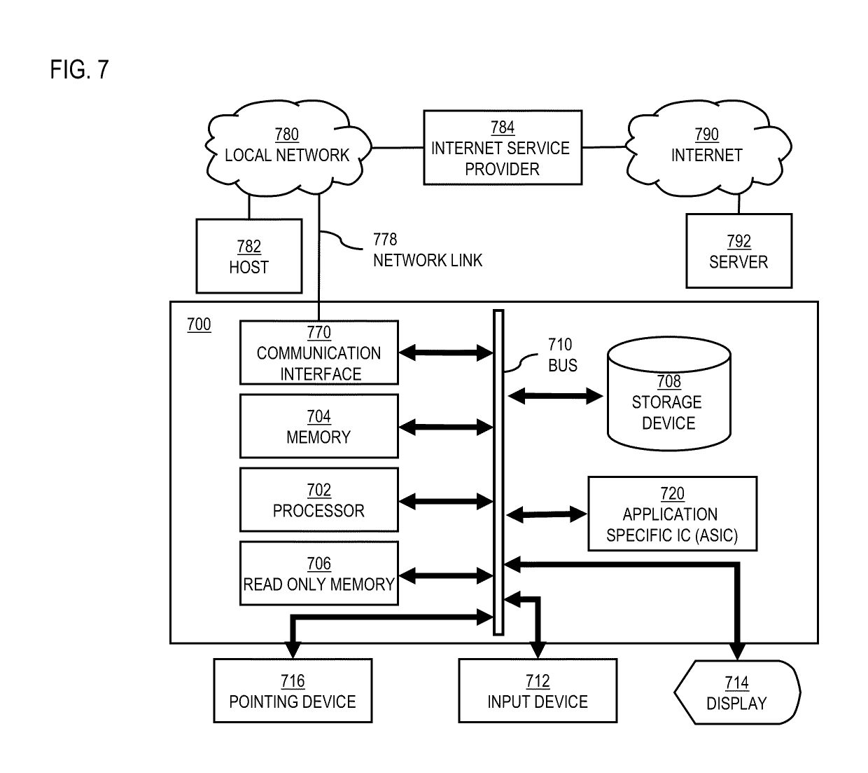

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide generation of a collaborative playlist as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of providing generation of a collaborative playlist.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to provide generation of a collaborative playlist. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for providing generation of a collaborative playlist. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing generation of a collaborative playlist, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to provide generation of a collaborative playlist as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of services. Chip set or chip 800, or a portion thereof, constitutes a means for performing one or more steps of providing generation of a collaborative playlist.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide generation of a collaborative playlist. The memory 805 also stores the data associated with or generated by the execution of the inventive steps.

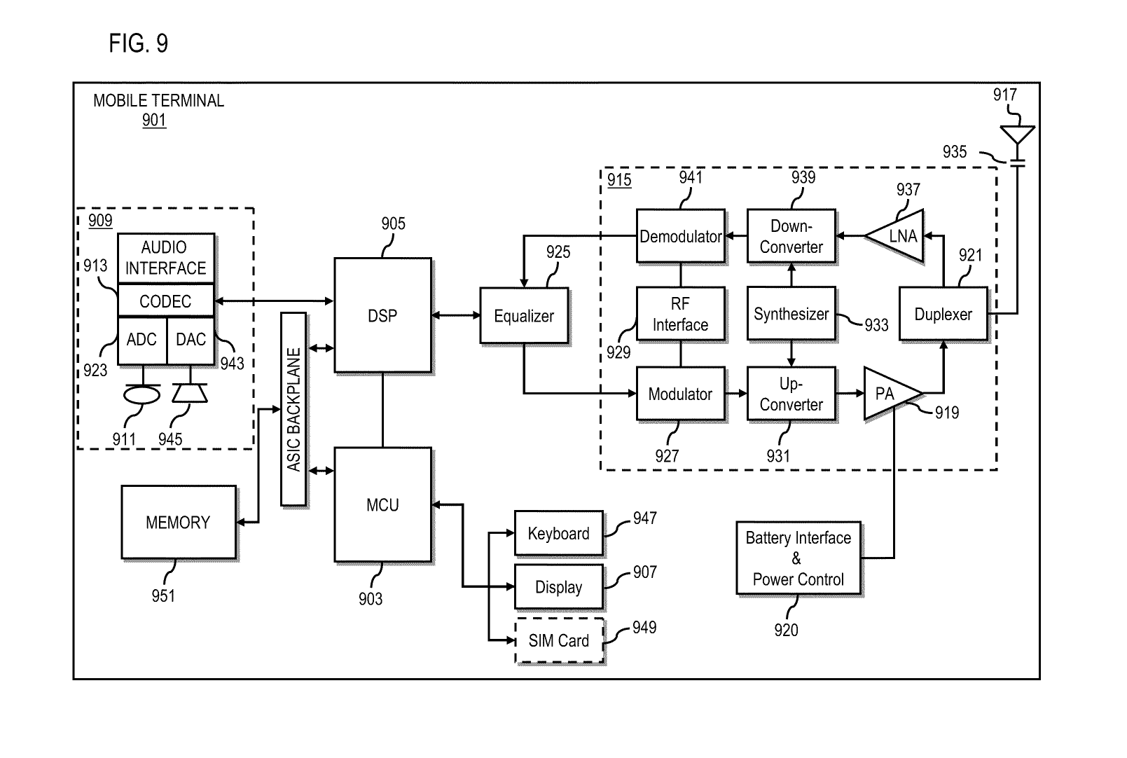

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of providing generation of a collaborative playlist. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of providing generation of a collaborative playlist. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to provide generation of a collaborative playlist. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating access to at least one interface configured to allow access to at least one service, the at least one service configured to perform at least the following:
receiving an input for initiating the creation of a collaborative playlist, the collaborative playlist based, at least in part, on one or more criteria; and
determining to transmit a notification of the collaborative playlist to a one or more devices,
wherein respective users of the one or more devices iteratively update the collaborative playlist.

2. A method of claim 1, wherein the service is configured to further perform:
receiving from a first one of the one or more devices a media track selection to add to the collaborative playlist; and
determining to transmit another notification of the media track selection to the one or more devices.

3. A method of claim 2, wherein the service is configured to further perform:
determining whether the media track selection are substantially within the one or more criteria; and
causing, at least in part, updating of the collaborative playlist based on the determination with respect to the one or more criteria.

4. A method of claim 2, wherein the other notification includes a link to the media track selection in a media service.

5. A method of claim 2, wherein the service is configured to further perform:
receiving a request for access to the media track from a second one of the devices;
determining that the second one device is not associated with an account;
determining to transmit a limited version of the media track selection to the second one device.

6. A method of claim 1, wherein the service is configured to further perform:
determining to transmit the collaborative playlist to the one or more devices.

7. A method of claim 1, wherein the notification is transmitted over a social network, a text message, a multimedia message, an electronic mail, an instant message, or a combination.

8. An apparatus comprising:
at least one processor; and
at least one memory including computer program code for one or more programs,
the at least one memory and the computer program code configured to, with the at least one processor, cause the apparatus to perform at least the following,
receive an input for initiating the creation of a collaborative playlist, the collaborative playlist based, at least in part, on one or more criteria; and
determine to transmit a notification of the collaborative playlist to one or more devices,
wherein respective users of the one or more devices iteratively update the collaborative playlist.

9. An apparatus of claim 8, wherein the apparatus is further caused to:
receive from a first one of the one or more devices a media track selection to add to the collaborative playlist; and
determine to transmit another notification of the media track selection to the one or more devices.

10. An apparatus of claim 9, wherein the apparatus is further caused to:
determine whether the media track selection are substantially within the one or more criteria; and
cause, at least in part, updating of the collaborative playlist based on the determination with respect to the one or more criteria.

11. An apparatus of claim 9, wherein the other notification includes a link to the media track selection in a media service.

12. An apparatus of claim 9, wherein the apparatus is further caused to:
receive a request for access to the media track from a second one of the devices;
determine that the second one device is not associated with an account;
determine to transmit a limited version of the media track selection to the second one device.

13. An apparatus of claim 8, wherein the apparatus is further caused to:
determine to transmit the collaborative playlist to the one or more devices.

14. An apparatus of claim 8, wherein the notification is transmitted over a social network, a text message, a multimedia message, an electronic mail, an instant message, or a combination.

15. A computer-readable storage medium carrying one or more sequences of one or more instructions which, when executed by one or more processors, cause an apparatus to at least perform the following steps:
receiving an input for initiating the creation of a collaborative playlist, the collaborative playlist based, at least in part, on one or more criteria; and
determining to transmit a notification of the collaborative playlist to one or more devices,
wherein respective users of the one or more devices iteratively update the collaborative playlist.

16. A computer-readable storage medium of claim 15, wherein the apparatus is caused to further perform:
receiving from a first one of the one or more devices a media track selection to add to the collaborative playlist; and
determining to transmit another notification of the media track selection to the one or more devices.

17. A computer-readable storage medium of claim 16, wherein the apparatus is caused to further perform:
determining whether the media track selection are substantially within the one or more criteria; and
causing, at least in part, updating of the collaborative playlist based on the determination with respect to the one or more criteria.

18. A computer-readable storage medium of claim 16, wherein the other notification includes a link to the media track selection in a media service.

19. A computer-readable storage medium of claim 16, wherein the apparatus is caused to further perform:
receiving a request for access to the media track from a second one of the devices;
determining that the second one device is not associated with an account;
determining to transmit a limited version of the media track selection to the second one device.

20. A computer-readable storage medium of claim 15, wherein the apparatus is caused to further perform:
determining to transmit the collaborative playlist to the one or more devices.

21.-39. (canceled)
